(19) United States
(12) Patent Application Publication
(10) Pub. No.: US 2009/0007132 A1
(43) Pub. Date: Jan. 1, 2009

(54) MANAGING PROCESSING RESOURCES IN A DISTRIBUTED COMPUTING ENVIRONMENT

(75) Inventor: Katiuscia Berretta, Rome (IT)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 12/211,504

(22) Filed: Sep. 16, 2008

(30) Foreign Application Priority Data
Oct. 3, 2003 (FR) 07301430.0

(51) Int. Cl. G06F 9/46; G06G 7/62

(52) U.S. Cl. 718/104; 703/13; 718/102

(57) ABSTRACT

Multiple timing availability chains can be created for individual processing resource in a common pool of resources. Each chain can include a plurality of time intervals each interval having a start time and an end time. Timing availability chains for individual processing resources in the pool of resources can be merged together based on a timing reference to create a pool timing availability chain based on the start times and end times for the intervals. Job plan execution can be simulated based on the pool timing availability chain. The pool chain can be utilized to simulate job execution and based on such simulation a job scheduler can improve the scheduling of jobs on a pool of resources. Other embodiments are also disclosed.

### CROSS-REFERENCE TO RELATED APPLICATIONS

This application claims priority to an application filed in France, application number 07301430.0 entitled A Method and Computer Program for Planning Job Scheduling on a Pool of Systems, filed on Oct. 3, 2007.

### BACKGROUND

The present disclosure generally relates to management of large processing workloads. The present disclosure further relates to dividing the large processing workload into tasks, assigning the tasks to multiple processing resources and managing non-specialized processing resources.

Information technology (IT) and enterprise computing resources continue to become more complex and sophisticated. When an IT infrastructure supports a significant number of systems, it is desirable to install enterprise tools or enterprise software to manage the overall system. One such enterprise tool is a job scheduler. A job scheduler can be viewed as a set of programs for assigning tasks, scheduling tasks and automatically starting job execution on these different systems. One role of a job scheduler is to successfully submit jobs on different systems or different system components. Other rolls of a job scheduler include monitoring system operation, analysis, tuning, and reporting.

Generally, job schedulers are able to minimize idle-time, improve data throughput and insure timely completion of mission-critical processing activities on an enterprise system. One such workload scheduler is available from Tivoli Incorporated (a subsidiary of Internal Business Machines Corporation (IBM) provides a workload scheduler for a “z” operating system that launches and tracks each task or job and manages a number of activities enterprise-wide from a single point of control. This workload scheduler can automate system operation and can control the processing of an entire enterprise system or can provide enterprise wide production workloads. Thus, a typical workload scheduler manages much more than just a batch subset.

Traditional batch jobs including any activity that can be scheduled for execution on a system or execution on part of a system can be referred to as a job. One function of job schedulers is their ability to plan for job based processing. Planning generally, is the ability to consider or determine system parameters such as capabilities and capacities, to prepare a plan for job execution, and to execute the plan.

Generally, a planer can prepare a plan for a job scheduler where the plan ensures that all jobs will be executed. In some embodiments, a user can manually configure jobs such that they are executed on specific resources. It can be appreciated that a job scheduler will typically follow an original plan that is created by the planner. However, even after a plan is created by the planner the job scheduler can make changes to the schedule based on events. Further, a user may change the plan via input to a user interface.

A typical planner can prepare a job submission according the job's duration, IT resource consumption, resource availability, resource timing considerations, resource specialties and capacity of the processing resources or target system(s). Resource capacity can be expressed as the number of jobs that can be executed simultaneously on one resource (Resource Capacity). When making a plan a planner can evaluate job requirements and the availability of the target system.

A user can define a set of alternate processing resources should the assigned processing resource be unavailable when needed. Planning functionality can take into account the availability and capacity of each target processing resource. The planner can plan the execution of a job in a specific time period if at least one competent target resource is available during that time period. Accordingly, the pool of processing resources can be considered as a single system in terms of availability for processing a job. The planner can calculate times and dependencies and can then provide the job scheduler with the execution plan. This feature can improve the utilization of IT resources and overall system efficiency.

Efficient use of IT resources is a design goal for IT personal who operate enterprise systems with processing resources that are distributed in different locations in the world, where the processing resources have different availability periods. Planning methods that can plan for distributed processing of jobs consider resource availability and capacity are less than perfect.

### SUMMARY

In some embodiments, a method for planning submission of multiple jobs to multiple processing resources of a pool of resources is disclosed. The planning process can take into account parameters such as job duration, capacity, available time periods for processing resources and resource usage for each processing resource in a pool of resources.

In some embodiments, the method can include creating a plan and simulating an execution of the plan by simulating the execution of multiple jobs. Planning can include generating a time period availability analysis for each processing resource and synchronizing each time period availability analysis to create relational timing availability between processing resources. An indicator can link a time period availability chain with a processing resource and a processing resource with a resource pool. Considering the relational timing between the availability of different processing resources, a time period chain of availability can be created where a job, or results of a job, can move from processing resource to processing resource based on when processing resources become available in time. Thus, results of a job from a first processing resource can be sent to a second processing resource based on time period availability in accordance with the time period chain of availability analysis in a plan.

The simulation can start based on a requirement for executing a job, a time estimation for executing the job on a particular processing resource, and the time period availability chain of processing resources. Availability chains can be utilized to coordinate jobs with processing resources that become available over a span of time where jobs are processes.

In some embodiments individual availability chains can be merged to create a resource pool availability chain. For example, a first availability chain indicator can indicate that the first availability chain indicator is associated with a first processing resource and a first pool of available resources. A next or second availability chain indicator can indicate that the second availability chain is associated with a second processing resource and the first pool of resources. If the availability chains are associated with the same pool of resources the first and second availability chains can be merged using a time integration, chain intervals, or time intervals to form a “new” or third availability chain.

The third availability chain can be defined as a timing chain for more than one processing resource in a pool thus; merging can create a resource pool time availability chain. Once a resource pool time availability chain has been created, the simulation program can utilize the plan and the pool time availability chain to simulate processing of the jobs in a time sequence. The resource pool availability chain can include information on processing resource capacity and such a capacity can be defined in a capacity limitation number. The capacity limitation number can indicate a maximum number of jobs that can be processed simultaneously.

In some embodiments, instructions for computing time period availability for individual processing resources can be combined or merged to create a time period availability for a pool of resources. Accordingly, the disclosed arrangements add a logical layer planning functionality when a pool based availability chain is created and utilized in a simulation. The instructions for computing both time period availabilities capacity of the pool of resources may be implemented as one logical layer adding functionality and accuracy to planning applications.

Defining a timing chain for multiple processing resources in a pool of resources as compared to defining a timing chain for a single resource, single resources in a pool or alternate resources can improve resource allocation and resource usage in a resource pool. It can be appreciated that the configuration of the processing resources and the plan can change from the time when the simulation takes place to when the jobs are actually executed. Such changes can be due to changes to the processing resources, to the pool of resources and to the internal IT architecture generally between the simulation and the time of execution.

In some embodiments a logical entity can be built that represents the availability of multiple resources in a pool of resources. The logical entity can be stored to a system memory. The logical entity can allow the simulation portion of the planner to consider the entire pool of resources as a unique system. Monitoring or querying all target resources in a pool of resources to locate a first available resource can provide alternative ways to plan scheduling of jobs on a pool of resources.

Traditionally, when no availability chain is created for a pool and a large number of jobs are tightly scheduled on a pool of resources, the actual performance of the pool of resources can be compromised. Creating an availability chain for the pool of resources, thereby allowing the pool of resources to operate as a “single” entity provides less idle time for resources. When timing is managed via a pool availability chain, performance by the pool of resources will not be significantly reduced even when a large number of jobs are tightly scheduled.

### BRIEF DESCRIPTION OF SEVERAL VIEWS OF THE DRAWINGS

FIG. 1 is a block diagram of a system capable of processing jobs;

FIG. 2 describes a time sequence diagram for a plurality of pools;

FIG. 3 is a flow diagram depicting ways to determine availability periods of time information for a pool of resources;

FIG. 4 is another flow diagram depicting ways to merge two successive availability and capacity chains;

FIG. 5 is another flow diagram depicting ways to merge overlap when the interval start time is determined before an interval start time;

FIG. 6 is a flow diagram depicting ways to merge overlap when an interval end time occurs after a time interval end time;

FIG. 7 is a flow diagram depicting merge overlap when the interval start time is before the interval start time; and

FIG. 8 is a flow diagram depicting merge overlap when the interval end time is after the interval end time.

### DETAILED DESCRIPTION

The following is a detailed description of the embodiments depicted in the accompanying drawings. Arrangements in the form of systems, apparatuses, methods and computer readable media are disclosed herein that can provide efficient simulation of jobs to be executed in a distributed processing environment.

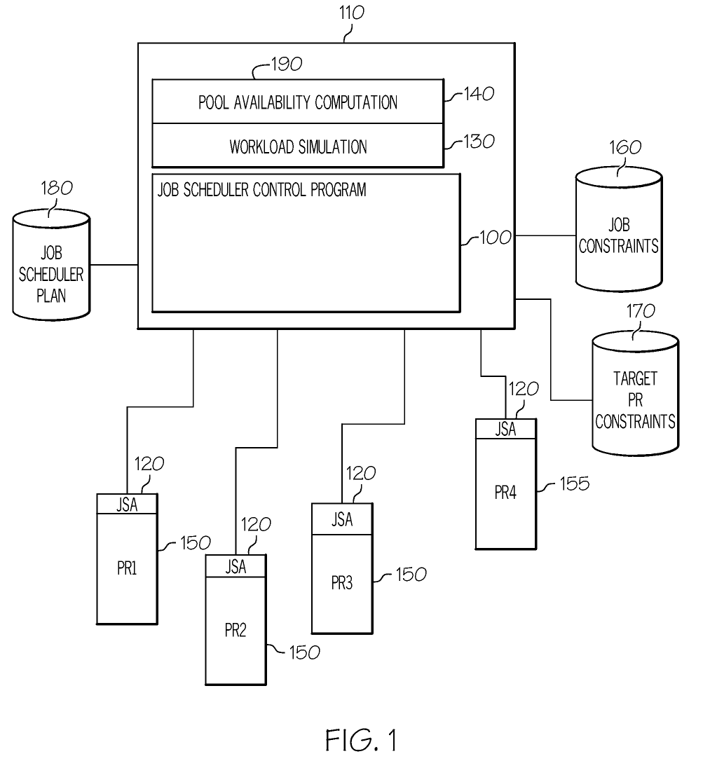

FIG. 1 is a block diagram of a simulation system 110 capable of simulating job execution for a distributed processing system that utilizes time period availability chains to coordinate job timing. The distributed processing system can include a plurality of job scheduling agents (JSA)s 120 that schedule jobs for processing resources or processing resources 150 and 155. The simulation system 110 can store and retrieve data from a job scheduler plan module 180, a job constraint module 160, and a target resource or processing resource constraint module. The job constraint module 160 and the target system or processing resource constraint module can contain memory and can contain a database that is dynamic and contains information about the jobs, the processing resources and constraints on jobs and resources.

The simulation system 110 can retrieve a scheduling plan from the job scheduler plan module 180. In addition, the simulation system 110 can store data in the job scheduler plan module 180 and in some embodiments, can alter or modify the data and instructions stored by the job scheduler plan module 180. The job scheduler plan module 180 can provide numerous functions and features, however many such functions and features such as the functions of a scheduler are beyond the scope of this disclosure. This disclosure focuses generally on simulating the execution of jobs utilizing job constraint data, processing resources constraints, a job scheduling plan and timing availability chains for individual processing resources and a timing availability chain for the pool of processing resources, wherein the processing resources create a distributed processing system.

Generally, a job scheduler can be implemented by two distinct applications one application running on a main controller and other applications running on processing resource. A job scheduler control program 100 can be installed on the simulation system 110 and other schedulers can be operational JSAs 120. JSAs can interface with processing resources or systems 150 and 155. The processing resources 150 that are controlled by the job scheduler control program 100 can be connected locally or connected remotely to a master JSA or processing resource 155. In addition, the job scheduler control program 100 can communicate with processing resources 150 and 155 via a local or remote connection to JSAs 120. Such a connection can be utilized to send commands, receive results or statuses and to submit jobs to the processing resources.

In some embodiments, the simulation system 110 can include a planning program or planner 190 that includes a pool availability computation module 140 and a workload simulation module 130. In some embodiments, the job scheduler control program 100 can be executed at remote location such as by remote JSA 150. However, the job scheduler control program 100 could be installed on any system or processing resource including a processing resource controlled by a job scheduler on which a job scheduler agent is installed and operational. The processing resources 150 and 155 that are controlled by the job scheduler control program 100 can be one or more large computers operating as enterprise systems or smaller computing systems such as individual processors, personal computers or individual workstations that can communicate with each other.

In some embodiments, simulation system 110 can simulate workload scheduling and a plan can be tested. Changes to the plan can be made as a result of the simulation and a revised plan can produce an improved plan. The instructions provided by the planner 190 can be executed as a batch job independently from the job scheduler control program 100.

The job scheduler planner 180 can implement workload simulation instructions from a workload simulation module 130 as a single software layer or as a dual layer. The workload simulation module 130 can assist in simulating job execution on selected processing resources 150 and 155. The job execution can have a predetermined, estimated or calculated time duration. The workload simulation program can determine availability time periods of the selected processing resources 150 and 155 during predetermined time durations. The availability time periods for each processing resource 150 and 155 can be stored in a target processing resource constraint module, hereinafter referred to as “PRCM” 170.

The simulation system 110 can retrieve availability time periods from the PRCM 170 and can retrieve revisions or changes to timing predictions that may have occurred. These changes may have resulted from direct or indirect user input or from results created by previous simulations or estimations. The scope of the timing prediction, changes to timing prediction and types of user input that could create such changes to availability time periods are beyond the scope of this disclosure. Thus, the scheduler control program 100 and/or the job scheduler plan module 180 can retrieve timing data and timing revision data from the PRCM 170. The planner 190 can also retrieve identifiers for jobs which need to be executed on the processing resources 150 and 155 and job durations for a particular job. Accordingly, an estimated or predicted duration for an execution time of a job on a specific processing resource 150 and 155 can be stored in processing resource/job constraints module 160.

A plan to be simulated can be stored in the job scheduler planner 180, and the planner 180 can provide a plan for scheduling of jobs to specific controllers or control modules within the system. Simulation of the plan can be performed utilizing most or all of the processing resources that are controllable by the job scheduler control program 100. The simulation system 110 can activate the job scheduler control program 100 and in turn the job scheduler program 100 can execute code and utilize the PRCM 170 and the job constraints module 160 to simulate execution of the plan.

The simulation system 110 can include a pool availability computation module 140 that adds another processing layer to job planning. The availability computation can predict and or determine times required to process jobs on specific processing resources and determine relative timing of when individual processing resources are available and when such resources are not available.

The simulation system 110 can simulate execution of a plan where the simulation considers the pool of processing resources as a whole, instead of combining single resource simulations. Thus, simulation system 110 can consider the timing availability relationship between processing resources in the pool of resources. The job scheduler plan 180 can be utilized to determine if there is a time sequence availability of processing resources or a chain of availability of processing resources.

This new software layer, the pool availability computation module 140, can retrieve data from the PRCM 170 to determine the availability periods or time periods of availability for each processing resource in the pool of resources. The pool availability computation module 140 can determine if a processing resource is available or will be available when a job is planned for a specific time duration.

A relationship between resource identifiers and pool identifiers may be stored in the PRCM 170. The simulation system 110 can compute availability periods of time for processing resources based on jobs and job durations. These computed resource availability time periods can be provided by the job scheduler planer 180 to the workload simulation module 130. The simulation module 130 can read and use the availability periods associated with resources to provide simulation of job executions on the entire pool of resources. Providing simulations utilizing timing availability of multiple processing resources that may be operating concurrently can provide improved results over simulations performed on single resources. Accordingly, job scheduling plan computations on pools of processing resources allows for accurate simulation. Such a job scheduling simulation can adjust availability periods of resources in the pool of resources.

The simulation can take into account the timing relationship between when processing resources are busy and when they are available and when they will become available (i.e. availability periods of processing resources) and results of such a simulation can be stored by the PRCM 170 and the job constraints planner 180 and such data can be utilized to determine resource capacity. The resource capacity constraint for each processing resource can be expressed as the number of jobs simultaneously executed on each processing resource during a processing resources availability period.

The resource capacity constraint as stored in the job constraints module 160 can be utilized by the workload simulation module 130 to create a plan for scheduling of jobs on each processing resource while optimizing the number of jobs executed on each processing resource during the planned time duration. Similarly, the job scheduler plan module 180 can create a plan for scheduling of jobs on a pool of processing resources, taking into account the capacity constraint for each resource. It can be appreciated that the planner module 190 can include a pool availability computation module 140 which can utilize data from PRCM 170 and the capacity constraints to determine the availability time periods of processing resources during the planned time duration.

The pool availability computation module 140 can determine when a job is in process, when a job is scheduled, when a job is complete or when a processing resource is available or will become available and such data regarding availability and status adds and/or improves planning functionality to the features provided by the workload simulation module 130. Thus, the computation module 140 can compute start times and end times for availability periods of processing resources and, by computing each availability period for each processing resource, the computation module 140 can determine the maximum number of jobs that can be simultaneously submitted to and processed by the pool of processing resources. Such a constraint or maximum capacity is referred to as “MC” herein.

Conducting a simulation that utilizes resource parameters and resource constraints can provide indicators of job scheduling conflicts, idle periods for each processing resource, periods when all resources are busy and busy periods for each processing resource. Such indicators can also include timing relationships of processing resources such as situations where resources or results from resources become available in succession. This chain or succession of events can be important when results from a first processing resource are needed by a second processing resource to complete a job. Simulating the execution of multiple jobs utilizing different types of timing data provides important timing based data to schedulers and planners such that schedulers and planners can attempt to optimize the use of processing resources in a pool. For example, a planner can increase a duty cycle or usage of the pool of resources, thereby increasing the pool's processing capacity. Accordingly, capacity constraints can be computed by the pool availability computation module 140 and such a computation can be stored in the PRCM 170.

The scheduler planner module 180 can monitor operating and/or simulated operating parameters that define various states of the processing resources or various states of processing resource components. For example, the scheduler planner module 180 can retrieve and utilize results from specifications provide by a processing resource (i.e. processor speed, amount of random access memory, type of operating system, etc.) In some embodiments additional data can be gathered during system simulation. Such data can include memory usage, central processing unit (CPU) clock speed, CPU usage rate, input/output (I/O) rate, etc. In some embodiments, capacity constraints for each processing resource can be identified and stored.

Such capacity constraints can include analyzing specific time periods by simulating processing resource that may be available during specific time periods. These capacity constraints can be determined utilizing a process for the computation of availability periods or intervals, computations for the capacity of processing resources and capacity of the pool in its entirety. The choice of capacity constraint can be related to the number of jobs which can be simultaneously submitted to the pool of resources and the workload target or number of jobs to be that can be acceptable for a particular installation/implementation.

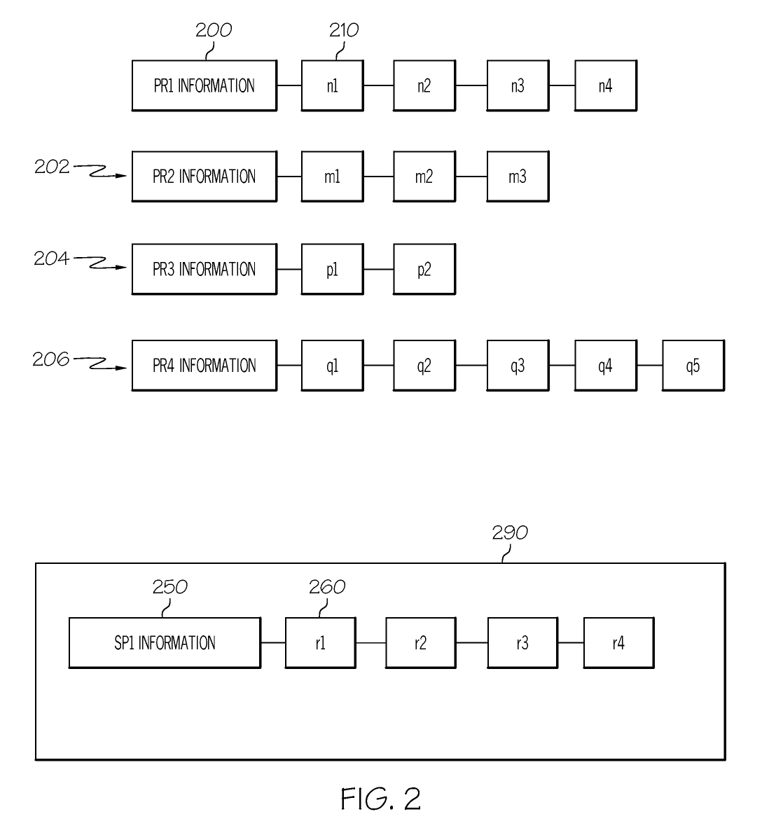

FIG. 2 illustrates a time period availability chain or capacity chain for individual processing resources. Such a chain can illustrate the computed availability of resources in the pool for a succession of time periods. The time availability chain illustrated can be calculated during a planning stage. The time period information regarding the availability of single processing resources can be stored in the PRCM as described above. However, such information can also be stored in memory local to the planning resources to increase performance.

Processing resource constraints are represented by four processing resources (PR) including PR1 200, PR2 202, PR3 204 and PR4 206. The constraints can include information on individual processing resources and such constraints can be associated with a resource identifier or processing resource identifier, such as PR1 (200). Information that is associated with the identifier can be retrieved by and utilized by a job scheduler controller and a job system agent as described above. The constraints can be utilized by the job scheduler controller and job system agent and the job scheduler can utilize the constraints to schedule the submission of jobs to one or more processing resources. The information can include time period availability information for a specific processing resource for example, availability information n1 210, for PR1 200. The availability information is illustrated in chronological order or a chain for planned time duration such as n1, n1, n2, n3, and n4, for PR1 200, m1, m2, and m3 for PR2 202, p1 and p2 for PR3 204, and q1, q2, q3, q4, and q5 for PR4 206.

Each availability period for each processing resource, such as availability period 210 for PR1 200 can include a number of jobs scheduled for simultaneous execution on the processing resource for a particular period. The availability time period for n1 210 could be defined in real time, such as between 8 am and 10 am on a particular day. Accordingly, the scheduler can determine that only two jobs can be executed simultaneously during this time period due to limited processing resources at this time and day.

The availability time periods can be divided into additional time blocks such as the second availability period of time n2 for PR1 200. For example, n2 can indicate a time interval from between 11 am and 1 pm, and n2 can define the capacity to execute eight jobs simultaneously. Thus, the information stored in each availability period can be utilized to plan and understand resource capacity.

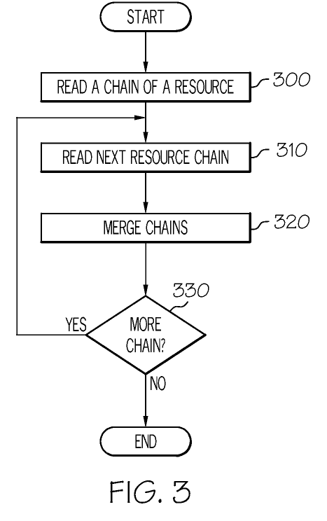

The lower portion of FIG. 2 illustrates a time period availability chain that includes information for a resource such as a coordinated processing resources or a pool of resources 290. The disclosed availability chain includes information that can be computed by the additional layer of the planning functionality disclosed herein. FIGS. 3-8 below describe ways to compute such information. The computed availability chain information for the pool of resources can be utilized by the simulation layer to simulate job execution on the pool as a whole and such a simulation can provide data that can be utilized to create a plan or schedule or to improve an existing plan or schedule.

The resource pool information 290 for processing resources of PRs 1-4 can be combined in a single module as illustrated by pool information, Sp1 250 having a chain of time blocks r1 260 r2, r3, and r4. When the data on the individual processing resources is combined with data from the individual processing resources and time blocks data can be associated with a time blocks, a specific processing resource and a pool resource identifier such as Sp1 250. Thus, processing resources can move between pools and such identification can determine what pool a resource is assigned to during a specific time period.

Thus, multiple resource identifiers such as Sp1 (PR1, PR2, PR3 and PR4) can be utilized to associate timing information with processing resources. This information can also be associated with a chain of availability period information (r1, r2, r3, r4) 260 as calculated. The timing information can be entered into a database in chronological order where each entry can have a planned time duration. For example, r1 availability period of Sp1 pool can be from 8:30 am and 12 pm on a particular day in the planned time duration. In the resource pool information shown for Sp1, four availability periods r1-r4 260 have been computed for the plan time duration.

Each availability period can include information, illustrated as (r1, r2, r3, r4) 260 for each pool, where the information can include a number of jobs that the processing resource can concurrently or simultaneously execute. Thus, the information stored for each availability period information (n1, n2, n3, n4) 210 can be utilized to determine pool or resource processing capacity.

Referring to FIG. 3, a flowchart depicting a method for computing availability periods for a pool of resources is depicted. As illustrated by block 300, data can be acquired on a processing resource. The data can include availability or unavailability of the resource during one or more time intervals. The time intervals can be organized based on a time reference. In some embodiments, a start time can be the time reference and all time intervals can have a start and stop time that occurs relative to the time reference.

The time intervals can be organized chronologically and thus a chain of time intervals can be formed for individual processing resources. The availability chain can be stored in a constraint database and can be retrieved from the constraint database. The availability chain can also include other constraints related to the chain of availability time periods such as capacity and maximum capacity indicators. As illustrated by block 310, availability chain data for a second processing resource can be acquired. As illustrated by block 320, the first chain can be merged with the second chain to form a resource pool availability chain.

As illustrated by decision block 330 it can be determined if there is any more chain data to be read. If there is not any more chain data to be read, then the process can end. If there are more unread chains in the data base the process can revert to block 310 the next chain can be read and merged at block 320. The process can continue until all chains are merged into the resource pool availability chain. After all individual resource chains are merged, the resulting pool chain can provide a computed availability chain for an entire pool of processing resources. Stated another way the pool chain of timing availability can be computed by merging time periods (available or unavailable) or a chain of individual time intervals for each individual processing resource.

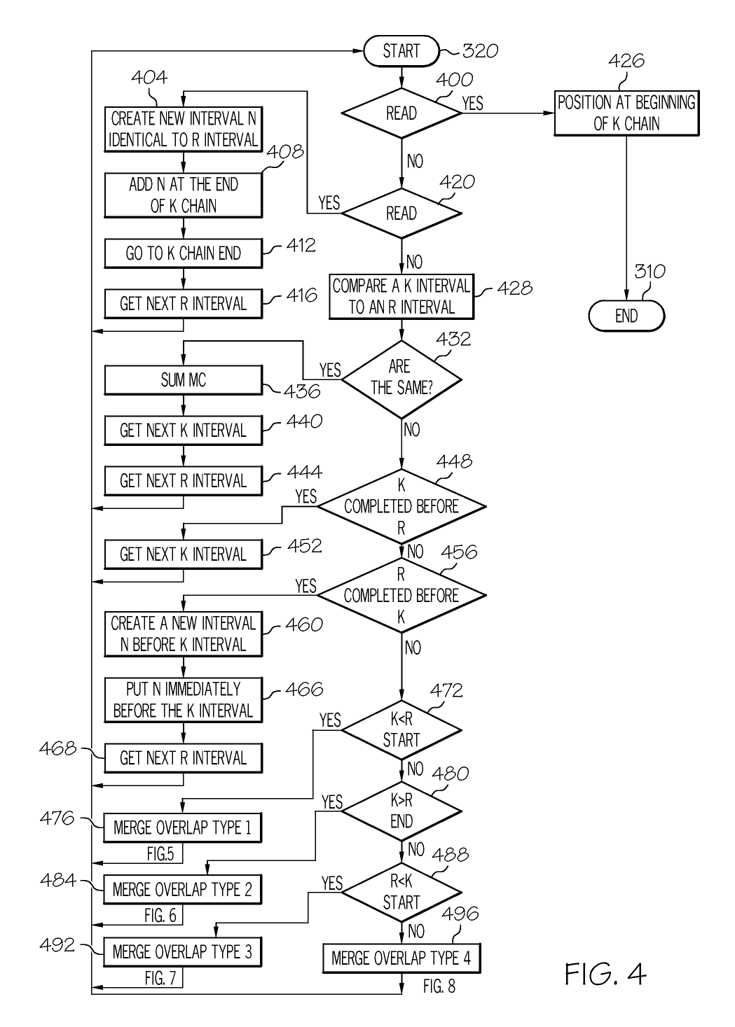

Briefly referring to FIGS. 4, 5, 6, 7, and 8 the flowcharts described refer to resource availability information. The resource availability information can include the pool capacity limitation number or the number of jobs which can be simultaneously executed on the pool of resources for each time interval in the availability chain as described above. In addition, the flowcharts described in FIGS. 4, 5, 6, 7 and 8 can apply or be utilized even when there is no known resource capacity information or no computation of resource pool capacity information. Thus, blocks referring to the capacity limitation can be skipped in the disclosed processes and such an interpretation should not be considered as limiting the scope of this disclosure.

Referring to FIG. 4, a flowchart is depicted for merging timing availability chains for individual processing resources. The merging of processing resource availability timing chains is part of the availability computation process above (see block 320 in FIG. 3). In some embodiments, resource availability timing information or availability chain timing data can include capacity information and capacity constraints for individual processing resources and for a pool of resources as a whole. Data about an interval can be tracked. Such data con include data that indicates a start time, an end time and a maximum capacity (MC). As stated above, the maximum number of jobs that can be effectively executed simultaneously (i.e. MC) in each time interval in the chain can be referred to as a capacity limitation number and such an indicator can be calculated as each time interval is merged into the pool chain.

As described above, the availability information of a single processing resource can be represented as a chain of time periods referred to as “intervals” in the chain. Each interval can have a start time and an end time where the start time and the end time can be known relative to a reference time point. A first chain can correspond to a first processing resource of the pool. The first chain can initially act as the pool resource chain, then other chains from processing resources can be merged with the initial/first chain.

Thus, the pool chain can be modified as additional processing resource chains are merged into the pool chain. In the disclosed process “R” can denote a chain for an individual processing resource that is “a next to be processed” chain or next to be merged chain. Thus, R can be acquired from memory and then can be merged into the pool chain K, during the disclosed merging process.

Generally, for merging an R chain into a K chain, a time interval from the K chain can be compared to an interval of R chain to see which time interval is first in time. Thus, R intervals get put into the K chain based on their relative timing to intervals in the K chain. When all intervals are merged, the process can be at the “end” of an R chain as and such a situation can be detected as illustrated by decision block 400. When the process is at the end of an R chain the process can reposition at the beginning of the K chain as illustrated by block 426 and the merge process can be started again. Repositioning can put the process in a position to iterate, comparing the first time interval of the system pool availability chain to the first interval of the next system availability chain, i.e., R.

When the process is at the end of the K chain but not the end of the R chain, as illustrated by decision block 420, then as illustrated by block 404 a new time interval can be created at the end of the K chain. The new interval at the end of the K chain can be “identical” substantially identical or similar to the R interval under the merging process. Thus the start time, end time and MC can be the same as the R time interval is essentially being transferred to the K chain. The new N interval can be positioned or added at the end of K chain as illustrated by block 408. The process can go to the end of the chain, as illustrated by block 412 and the next R interval can be read as illustrated by block 416 and another iteration can occur. Thus, all R chain time intervals that occur after the end of the K chain can be added to the end of the K chain. If the process is not at the end of the K chain, in block 420, the process can start comparing intervals to see which interval ends first or is completed first, as illustrated by block 428.

Accordingly, while merging an R chain into the K chain, start times, end times and time intervals from the K chain can be compared to start times, end times and time intervals of the R chain and based on the compare the merge can occur. As stated above, and as illustrated by decision block 400 when the process determines that it is at the end of the R chain, possibly by reading an indicator, the process can reposition itself, or reposition the location of the timing analysis such that it will compare newly acquired R time intervals to time intervals at the beginning of the K chain.

If the process is not at the end of the K chain at block 420, time interval compares can take place at block 428 and as illustrated by decision block 432, it can be determined if specific properties of a K and an R interval are the same or similar. If the K and R intervals have the same or similar start times (i.e. the K interval start time (“Ks”) is equal to the R interval start time (“Rs”), and the same or similar end times (i.e. the K interval end time (“Ke”) is equal to R interval end time (“Re”) they can be considered loosely as “the same.”

If the K and R intervals are the same the maximum capacity (MC) of the K intervals (“MCk”) can be updated by adding in the maximum capacity (MC) of the R intervals (“MCr”). Thus, MCk can be calculated as MCk=MCk+MCr as illustrated by block 436. The next K and R intervals can be acquired as illustrated by blocks 440 and 444 and the process can iterate back to block 400.

If at block 432 the K and R time intervals are not the same it can be determined if the K interval under analysis is completed before the R interval under analysis. Thus, at decision block 448 it can be determined if the K interval is completed before the R interval is completed or Ke<=Rs. If the K time interval is complete first or Ke<=Rs, the next K interval can be acquired as illustrated by block 452 and the process can iterate back to block 400. This iteration moves a compare of a R interval down the K chain until a K interval is located that does not end until after the R interval is started.

Thus if at decision block 448 the K time interval does not end before the R interval starts (i.e. Ke<=Rs is not true), then, at decision block 456 it can be determined if the R time interval is completed before the K time interval starts. If R interval ends before the K interval starts or (i.e. Re<=Ks), a new interval identical to the R interval can be created, as illustrated by block 460. This new interval can “fill a void” in the K chain. The new interval N can have a start time that is before the K interval or can be assigned a time interval before the K interval, as illustrated in block 466. The next R interval can be acquired, as illustrated by block 468 and the process can iterate.

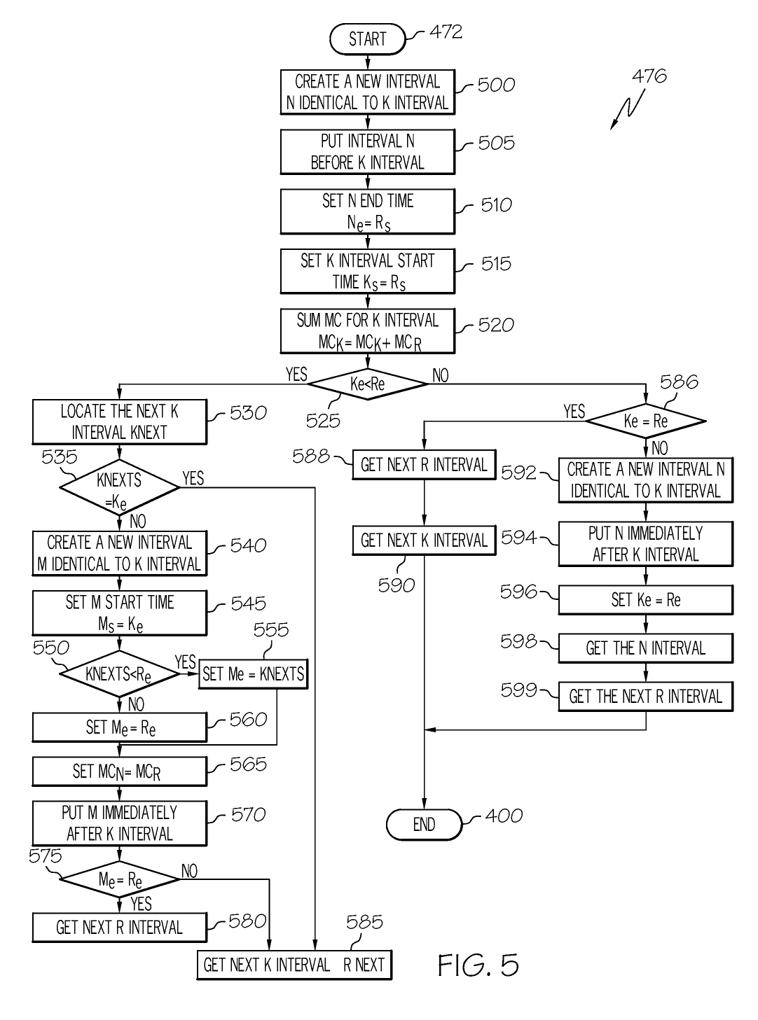

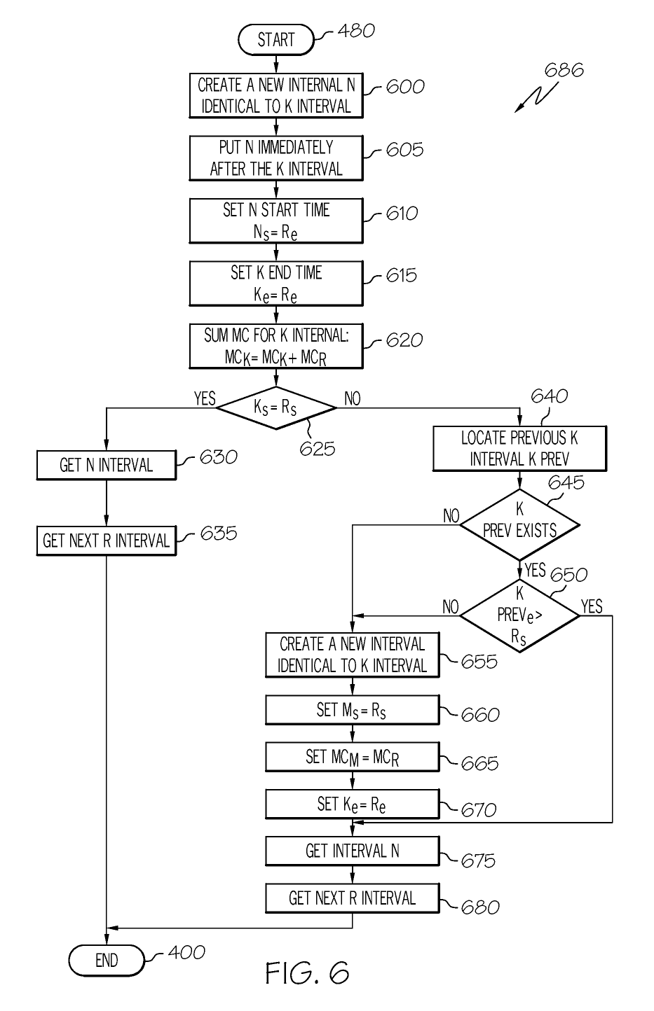

If at decision block 456 the R time interval is not completed before the K time interval starts (i.e. Re <=Ks) then, as illustrated by decision block 472 it can be determined if the K interval starts before the R interval start or Ks<Rs. At block 472 if Ks<Rs, a merge overlap type 1 can be performed. Details of such a type 1 overlap are described with reference to FIG. 5. The process can then iterate to the start position and block 400. At block decision block 472, if Ks>Rs then as illustrated by decision block 480 it can be determined if the end time of the K interval is after the R interval at end time or Ke>Re. If the K interval starts before the R interval and the K interval ends before the R interval the R interval would fall within the K interval. When such a situation exists a type 2 merge overlap can be performed as illustrated by block 484. Such a process is described in FIG. 6. The process can revert back to start position and block 400 and another iteration can be commenced.

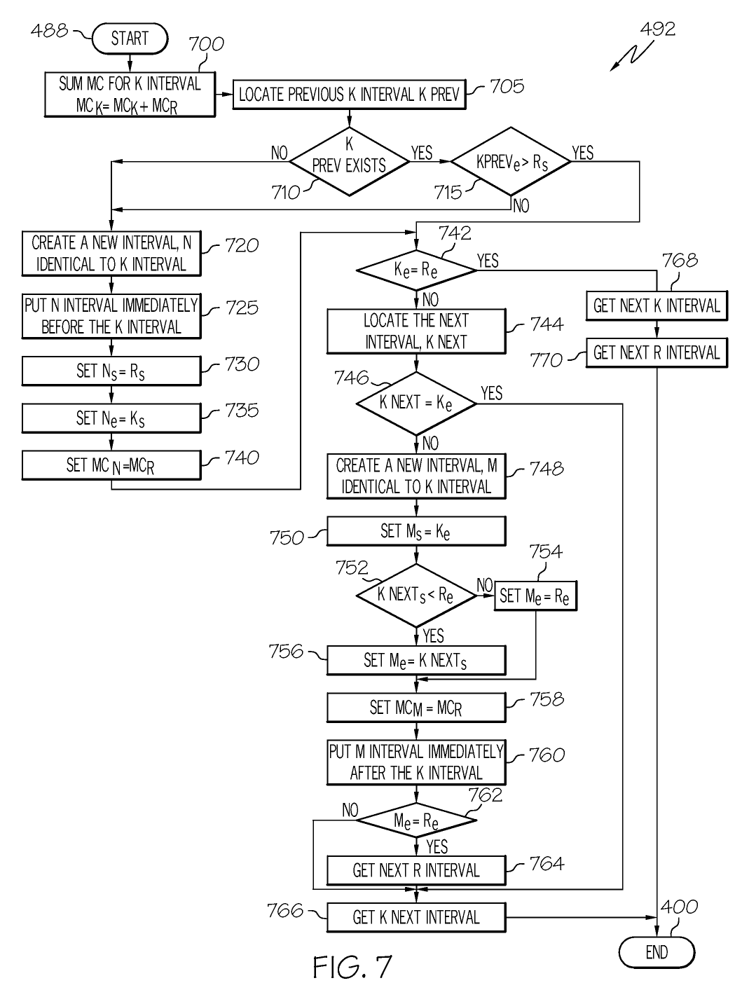

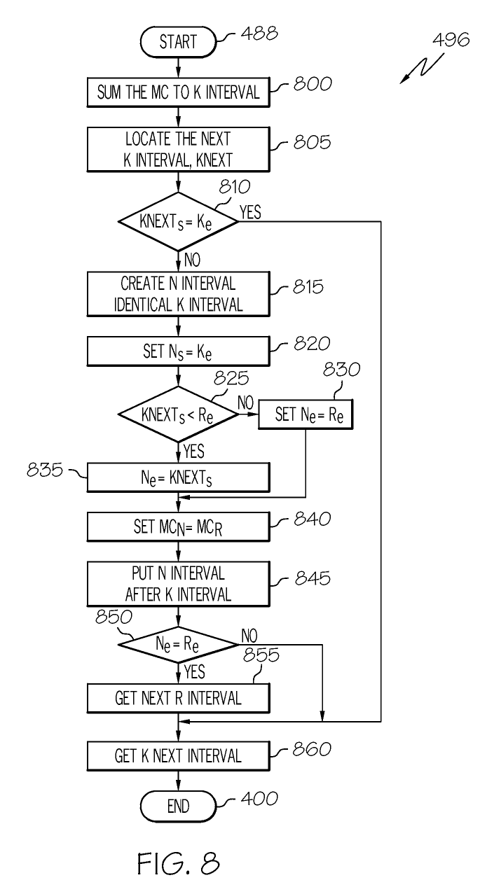

If Ke<Re, at block 480, it can be determined if the R interval start time is before the K interval start time (i.e. Rs<Ks) as illustrated by decision block 488. If the R interval starts before the K interval starts and the K interval ends before the R interval ends the K interval falls within the R interval and a type 3 merge overlap can be performed as illustrated by block 492. A type 3 merge overlap is described with reference to FIG. 7. The process can revert to the start position and another iteration can be commenced. If at decision block 488 Rs<Ks is not true, then a type 4 merge overlap can be performed as illustrated by block 496. A type 4 merge overlap is described with respect to FIG. 8 where the R interval does not encompass the K interval and the K interval does not encompass the R interval. The process can revert back to the start block and block 400 and another iteration can be commenced.

It can be appreciated that a type 1 merge overlap can be performed when a K interval start time is before a corresponding R interval start time; a type 2 merge overlap can be performed when the K interval end time is after R interval end time; a type 3 merge overlap can be performed when the R interval start time is before the K interval start time; and a type 4 merge overlap can be performed when the R interval start time is after the K interval start time.

Referring to FIG. 5, a flow diagram of a method that can be implemented for merging time intervals when Ks<Rs. As stated above, such a merging can be a type 1 merge overlap. As above, “K” represents the resource pool availability chain and “R” represents the next availability chain which has been read from memory or acquired by the resource. “Ks” represents a start time for the K interval and “Ke” represents an end time for the K interval and “Rs” represents a start time for the R interval and “Re” represents an end time for the R interval.

As illustrated by block 500 a new interval called an “N”, can be created where the N interval is similar to, or identical to the K interval. The N interval can be placed before the K interval in the K chain as illustrated by block 505. The end time of the N interval can be set equal to the start time of the R interval (i.e. Ne=Rs) as illustrated by block 510. As illustrated by block 515, the start time of the K interval can be set to the start time of the R interval (i.e. Ks=Rs). The MC of the K interval can be incremented (i.e. MCk=MCk+MCr), as illustrated by block 520. If the end time of the K interval is before the end time of the R interval (i.e. Ke<Re), as illustrated by decision block 525, the next K interval can be located as illustrated by block 530. The next K interval can be referred to as “KNEXT.”

If the start time of the KNEXT or (KNEXTs) is equal to the end time of the K interval (KNEXTs=Ke) as illustrated by decision block 535, then a KNEXT can be obtained as illustrated by block 585 and the process can end. If the start time of the KNEXT is not equal to the end time of the K interval, a new interval referred to as an “M” interval can be created as illustrated by block 540, where the M interval can have the same or a similar duration as the K interval. The start time of the M interval can be synchronized with the end time of the K interval (i.e. Ms=Ke) as illustrated by block 545. If KNEXTs is less than Re as illustrated by block 550, Me can be set equal to KNEXTs as illustrated in block 555. If KNEXTs is not less than Me, Me can be set equal to Re as illustrates in bock 560. The MC for M can then be set as follows: MCm=MCr as illustrated in block 565.

The M time interval can be placed immediately after the K interval as illustrated by block 570. If the end time of the M interval is the same as the end time of the R interval (i.e. Me=Re), as illustrated by decision block 575, the next R interval can be acquired as illustrated by block 580. Referring back to decision block 575 if the end time of the M interval is not equal to the end time of the R interval, the KNEXT interval can be acquired, as illustrated by block 585 and the process can end thereafter.

Referring back to decision block 535, if the end time of the K interval is not equal to the end time of the R interval (i.e. the end time of the K interval is not before the end time of the R interval), a check can be is performed on the end time of the K interval as illustrated by decision block 586.

At decision block 586, if Ke=Re, the next R interval can be acquired as illustrated by block 588 and the next K interval can be acquired as illustrated by block 590 and the process can move to block 400. If the end on the K interval is not equal to the end of the R interval, a new interval, N, identical in duration to the K interval can be created as illustrated by block 592. The newly created N interval can be placed immediately after the K interval in the chain as illustrated by block 594. The end time of the K interval can be modified such that it is equal to the end time of the R interval (i.e. Ke=Re) as illustrated by block 596. N interval can be obtained as illustrated by block 598 followed by acquiring the next R interval as illustrated by block 599. The process can move to block 400 as the type 1 merge overlap process can end.

Referring to FIG. 6 a flowchart for a type 2 merge overlap type is depicted. When Ke>Re the type 2 merge overlap process can build in the interval end time after the interval end time is read. As illustrated by block 600 a new interval N, similar or identical in duration to the K interval can be created as illustrated by block 600 and interval N can be placed immediately after the K interval as illustrated by block 605.

The start time for the N interval can be set equal to the end time of the R interval (i.e. Ns=Re) as illustrated by block 610, and the end time of the K interval can be set equal to the end time of the R interval (i.e. Ke=Re) as illustrated by block 615. The MC can be incremented for K interval as follows: MCk=MCk+MCr as illustrated by block 620. If the start time for the K interval is similar or the same as the start time for the R interval (i.e. Ks=Rs) as illustrated by decision block 625, the N interval can be acquired as illustrated by block 630 along with the next R interval as illustrated by block 635 and the process can end thereafter. If at decision block 625 the start of the K interval is not equal to the start of the R interval, the previous K interval (“KPREV”) can be located as illustrated by block 640.

As illustrated by block 645, if the K interval exists, and the end time of the KPREVe is greater than Rs, as illustrated by block 650, the N interval can be acquired as illustrated by block 675 along with the next R interval as illustrated by block 680 and the process can end thereafter. If at block 645, K does not exist or, at block 650 the end time of the KPREVe is not greater than Rs, it can be determined that the process is at the beginning of K chain (i.e. KPREV does not exist nor does the K interval end after the R interval). As illustrated by block 655, a new interval, M, identical in duration to the K interval, can be created.

As illustrated by block 660 the start time for the M interval can be set equal to the R interval start time (i.e. Ms=Rs). The MC for M can be set as follows: MCm=MCr as illustrated by block 665. As illustrated by block 670 the K interval end time can be set or changed such that it equals the end time of the R interval (i.e. Ke=Re). The N interval can be acquired as illustrated by block 675 and the next R interval can also be acquired as illustrated by block 680 and the process in FIG. 6 can end thereafter.

Referring to FIG. 7 a flow diagram for a type 3 merge overlap is disclosed. A type three merge overlap can occur when the R interval start time is before the K interval start time read (i.e. Rs<Ks), according to block 488 of FIG. 4. As illustrated by block 700, the MC of the K interval can be incremented as follows MCk=MCk+MCr. A KPREV interval can be located as illustrated by block 705. As illustrated by decision block 710, if the process is at the beginning of K chain or if no K chain exists or as illustrated by decision block 715, if KPREVe is not after Rs, a new interval, N, identical in duration to the K interval, can be created as illustrated by block 720.

As illustrated by block 725 the N interval can be placed immediately before the K interval in the chain. The start time of the N interval can be set equal to the start time of R interval (i.e. Ns=Rs) as illustrated by block 730. The end time for the N interval can be set equal to the start time of the K interval (i.e. Ne=Ks) as illustrated by block 735 and the MC can be calculated for the N interval as follows: MCn=MCr as illustrated by block 740.

The functions indicated in blocks 742 to 770 can be performed independently of blocks 720 to 740. As illustrated by decision block 742, if Ke=Re, the next K interval can be acquired as illustrated by block 768 and the R interval can be acquired as illustrated by block 770. If Ke is not equal to Re the next K interval (KNEXT) can be acquired or located as illustrated by block 744. As illustrated by decision block 746 if KNEXTs=Ke, the next K interval can be obtained or acquired as illustrated by block 766 and the type 3 merge overlap process can end. If KNEXTs is not equal to Ke, a new interval, M, identical in duration to the K interval, can be created as illustrated by block 748. As illustrated by block 750 the M interval start time can be set to the end time of the K interval (i.e. Ms=Ke). If KNEXTs<Re as illustrated by decision block 752, Me can be set as equal to KNEXTs as illustrated by block 756. If KNEXTs is greater than Re, Me can be set as equal to Re as illustrated by block 754.

The MC for the M interval can be set as follows: MCm=MCr as illustrated by block 758. The M interval can be placed after the K interval in the chain as illustrated by block 760. As illustrated by decision block 762, if Me=Re, the next R interval can be obtained or acquired as illustrated by block 764 and the next K interval can be obtained or acquired as illustrated by block 766. If Me is not equal to Re the next K interval can be obtained or acquires as illustrated by block 766. The type 3 merge overlap process can end thereafter.

Referring to FIG. 8, a flow diagram for a type 4 merge overlap is disclosed. A type 4 merge overlap can be implemented when the start time of the R interval occurs after the K interval start time. The subject flow diagram is a continuation of block 490 of FIG. 4 were Re>Ke. As illustrated by block 800 the MC for the K interval can be incremented as follows: MCk=MCk+MCr. As illustrated by block 805 the next K interval can be located or acquired. As illustrated by decision block 810, if KNEXTs=Ke, the next KNEXT interval can be obtained as illustrated by block 860 and the type 4 merge overlap process can end thereafter. If at decision block 810 KNEXT is not equal to Ke, a new interval, N, identical in duration to the K interval, can be created as illustrated by block 815. The start time for the N interval can be set as equal to the end time of the K interval (i.e. Ns=Ke) as illustrated by block 820. As illustrated by decision block 825, if KNEXTs<Re, Ne can be set equal to KNEXTs as illustrated by block 835. If KNEXT is not less than Re, the end time of the N interval can be set to the end time of the R interval (i.e. Ne=Re) as illustrated by block 830.

As illustrated by block 840, the MC for the N interval can be set as follows: MCn=MCr. The N interval can be placed after the K interval as illustrated by block 845. As illustrated by block 850 if Ne=Re, the next R interval can be obtained or acquired as illustrated by block 855 and the KNEXT interval can also be obtained or acquired as illustrated by block 860. If Ne is not equal to Re the next KNEXT interval is obtained as illustrated by block 860. The type 4 merge process can end thereafter.

Structuring the disclosed arrangements a different way, possibly adding modules or functions, utilizing similar multi-workstation communications and other changes are contemplated. For example, each function of each block described above could be sent to a different server. Likewise, the memory structures may be implemented in many different ways and may be replaced with similar or equivalent entities, where such entities may not necessarily consist of physical storage media.

The method can take any form suitable that can be utilized by or in connection with any data processing resource, such as external or resident software, firmware, or microcode (either in object code or in source code, for example, to be compiled or interpreted). A possibility may be to provide the program on any computer-usable medium; the medium can be any element suitable to contain, store, communicate, propagate, or transfer the program. For example, the medium may be of the electronic, magnetic, optical, electromagnetic, infrared, or semiconductor type. Examples of such medium may be fixed disks (where the program can be pre-loaded), removable disks, tapes, cards, wires, fibers, wireless connections, networks, broadcast waves, and the like. Some embodiments can be implemented with a hardware structure (for example, circuits integrated onto a semiconductor material), or with a combination of software and hardware. A possibility may include being able to deploy the disclosed embodiments as a service that can be accessed through a network, such as the Internet.

The proposed method may be carried out on a resource having a different architecture or including equivalent units, for example, based on a local network. Each computer may include similar elements, such as cache memories temporarily storing the programs, or parts thereof to reduce the accesses to the mass memory during execution. A possibility may be to replace the computer with any code execution entity (such as a PDA, a mobile phone, etc.), or with a combination thereof (such as a multi-tier server architecture, a grid computing infrastructure, and the like.)

Embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution resource. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

What is claimed is:

1. A method comprising:
creating a first availability chain, the first availability chain including a first plurality of time intervals indicating availability of a first processing resource during the first plurality of time intervals;
associating the first availability chain with a pool of processing resources;
acquiring a second resource availability chain associated with the pool of processing resources, the second availability chain having a second plurality of time intervals indicating availability of a second processing resource during the second plurality of time intervals; and
merging the first plurality of time intervals with the second plurality of time intervals based on a relative timing of the first and second plurality of time intervals to create a timing availability chain of the pool of resources.

2. The method of claim 1 further comprising selecting a merging process based on a start time and an end time of a time interval in the second plurality of time intervals and a start time and an end time of a time interval in the first plurality of time intervals.

3. The method of claim 1 further comprising simulating the execution of jobs based on the timing availability chain of the pool of resources.

4. The method of claim 3 further comprising utilizing the timing availability chain of the pool of resources to create a job execution plan on the pool of processing resources.

5. The method of claim 3 further comprising modifying a job schedule based on results of the simulation.

6. The method of claim 1 further comprising determining a start time and an end time of a first time interval and a second time interval and comparing the start time and the end time of the two time intervals.

7. The method of claim 6 further comprising utilizing a time reference to perform the comparing.

8. The method of claim 1 further comprising testing two time intervals to determine if the two time intervals are equal in duration.

9. The method of claim 1, further comprising calculating a maximum capacity indicator on the pool of resources.

10. A system comprising:
a job scheduler control program module to determine time intervals related to individual processing resources and to determine start times and end times for the time intervals;
a processing resource constraint module to store the time intervals and the start times and the stop times; and,
a pool availability computation module to compare the start times and the end times of the time intervals, to select a merge process for the time intervals based on the start times and the stop times, and to merge the time intervals utilizing the selected merge process to create a pool availability time interval chain indicative of an availability of processing resources in a pool of processing resources.

11. The system of claim 10 further comprising a workload simulator to utilize the pool availability time interval chain to simulate an execution of jobs.

12. The system of claim 11 further comprising a job scheduler to adapt a schedule of jobs to be run utilizing at least one processing resource from the pool of processing resources based on results from the workload simulator.

13. The system of claim 10 further comprising a job constraints module to store constraints on jobs to be executed by at least one processing resources from the pool of processing resources.

14. A computer program product comprising: a computer readable storage medium including instructions that, when executed by a processor;
creates a first availability chain, the first availability chain including a first plurality of time intervals indicating availability of a first processing resource during the first plurality of time intervals;
associates the first availability chain with a pool of processing resources;
acquires a second resource availability chain associated with the pool of processing resources, the second availability chain having a second plurality of time intervals indicating availability of a second processing resource during the second plurality of time intervals; and
merges the first plurality of time intervals with the second plurality of time intervals based on a relative timing of the first and second plurality of time intervals to create a timing availability chain of the pool of resources.

15. The computer program product of claim 14, that when executed by a processor causes the computer to select a merging process based on a start time and an end time of a time interval in the second plurality of time intervals and a start time and an end time of a time interval in the first plurality of time intervals.

16. The computer program product of claim 14, that when executed by a processor causes the computer to simulate the execution of jobs based on the timing availability chain of the pool of resources.

17. The computer program product of claim 14, that when executed by a processor causes the computer to utilize the timing availability chain of the pool of resources to create a job execution plan on the pool of processing resources.

18. The computer program product of claim 14, that when executed by a processor causes the computer to modify a job schedule based on results of the simulation.

19. The computer program product of claim 14, that when executed by a processor causes the computer to determine a start time and an end time of a first time interval and a second time interval and comparing the start time and the end time of the two time intervals.

20. The computer program product of claim 14, that when executed by a processor causes the computer to utilize a time reference to perform the comparing
